(19) United States
(12) Patent Application Publication
(10) Pub. No.: US 2011/0179681 A1
(43) Pub. Date: Jul. 28, 2011

(54) Method and device for marking, identifying and organizing personal clothing

(76) Inventor: Jennifer Beth Lamers, Rochester, MN (US)

(21) Appl. No.: 12/803,309

(22) Filed: Apr. 25, 2007

(51) Int. Cl. G09F 3/04; G09F 3/00

(52) U.S. Cl. 40/322

(57) ABSTRACT

Procedure and device for marking, identifying and organizing clothing. The device is temporarily affixed to a hanger by looping the device over the top hook part of a clothing hanger then conjoining an article of clothing on that same hanger. Once the device and article of clothing are conjoined in the hanging position, the device labels the article of clothing as a condition or state of use determined by device markings or user options. The device allows the user to mark clothing in categories such as worn or unworn, used or new, size, or could identify the status of an infinite number of clothes hung by sections on as many hangers with one device serving as the label for all articles of clothing in that section.

### REFERENCES CITED [REFERENCED BY]

### U.S. Patent Documents

| | | |
|---|---|---|
| 1,348,952 | August 1920 | Landey |
| 1,389,266 | August 1921 | Newton |
| 1,710,296 | April 1921 | Clark |
| 2,594,228 | April 1952 | Smith |
| 2,801,036 | July 1957 | Klein |
| 2,825,162 | March 1958 | Flood |
| 3,765,110 | October 1973 | Olsen |
| 5,056,248 | October 1991 | Blanchard |
| 5,238,159 | August 1993 | Zuckerman |
| 6,409,057 | December 2000 | Kim |
| 6,883,259 | December 2003 | Johansson |

### TECHNICAL FIELD

The invention relates to an identification-marking device for personal clothing, both being supported by a clothes hanger.

### BACKGROUND ART

The clothes hanger marking device of this invention applies to the individually tailored application for marking and therefore visually recording the status of the clothing item conjoined and supported by a hanger in either a personal and commercial application. The device allows the user to track and know the wear status or wear cycles of the conjoined article of clothing. Specifically, some individual applications label clothing with the device identifying the conjoined garment wear status, service requirement like dry-cleaning, wash cycle, age, or when an item is to be worn, and/or a wear cycle.

The device of this invention also provides individual flexibility such that one can tailor the use, matching personal needs for persons of any sex or age. Added benefits are that the invention adapts to almost any style clothing hanger or hook, and that clothing is marked with an easy attachment and detachment process. Because of the ease of the on and off attachment and detachment process, the further advantage of the product is reuse capability, giving extended value to the user over many applications without the need for replacement. The process for removal for repetitive use is the reverse of its conjoined placement with said hanger.

### DISCLOSURE OF INVENTION

The clothing identification marking device of this invention becomes conjoined with a hanging device that additionally supports an article of clothing. When attached by its integral hanger mounting slots or openings, the device visually labels the status of the hanging garment or garments. When attached to the hanger, the device generally hangs in the opening of a shirt collar or above an article of clothing looped above the horizontal portion of the hanger, such that the device is easily identifiable from the front facing of the garment and from the oblique. As the marking device hangs with the hanger-supporting loop, it identifies the status of that conjoined garment or garments on that hanger as optionally labeled by its user.

The invention identification tag may have a generally triangular, circular, rectangular or oblong shape. The device is constructed of a consistency to which it is durably attached and detached with many repetitions and forms to the hanging garment hanger in such a fashion that it does not protrude to the extent of interfering with a closely hung garment to its front. When attached to the hanger, the device is designed such that its presence on the hanger clearly projects its intended use, possibly aided by visually attractive bright colors and labeling.

### BRIEF DESCRIPTION OF DRAWINGS

The invention is described as the following by means of preferred embodiments, utilizing the accompanying drawings in which:

FIG. 1 is a frontal view of the invention conjoined by means of its integral hanging openings with a standard clothes hanger.

FIG. 2 is an embodiment side view of the invention apart from its hanging apparatus.

FIG. 3 is a detailed frontal view of the invention in relationship to its hanging apparatus.

FIG. 4 is a detailed 3D view of the invention apart from its hanging apparatus.

### BEST MODE FOR CARRYING OUT THE INVENTION

With reference to FIG. 1, the invention is manually conjoined with a standard clothes hanger by means of threading the hook and straight portion of said hanger top shown as 1B through the invention integral openings 1F to the point of its temporary resting place on said hanger downward sloping components shown as 1C and 1D. The device 1G hangs freely not withstanding its connection point with said hanger and its upper portion resting on hanger components 1C and 1D.

The invention then being attached to a standard hanger, depicted as 1A, by its integral openings 1F and resting on 1C and 1D, and because of the device flexibility from its manufactured material, forms downward from the attachment points 1F. In the position shown, the device 1G then remains flexible and un-obstructive to the process of hanging an article of clothing on said hanger 1A. Once the device is attached as depicted in FIG. 1, hanger and an article of clothing are conjoined in the hanging position; the device then labels the article of clothing.

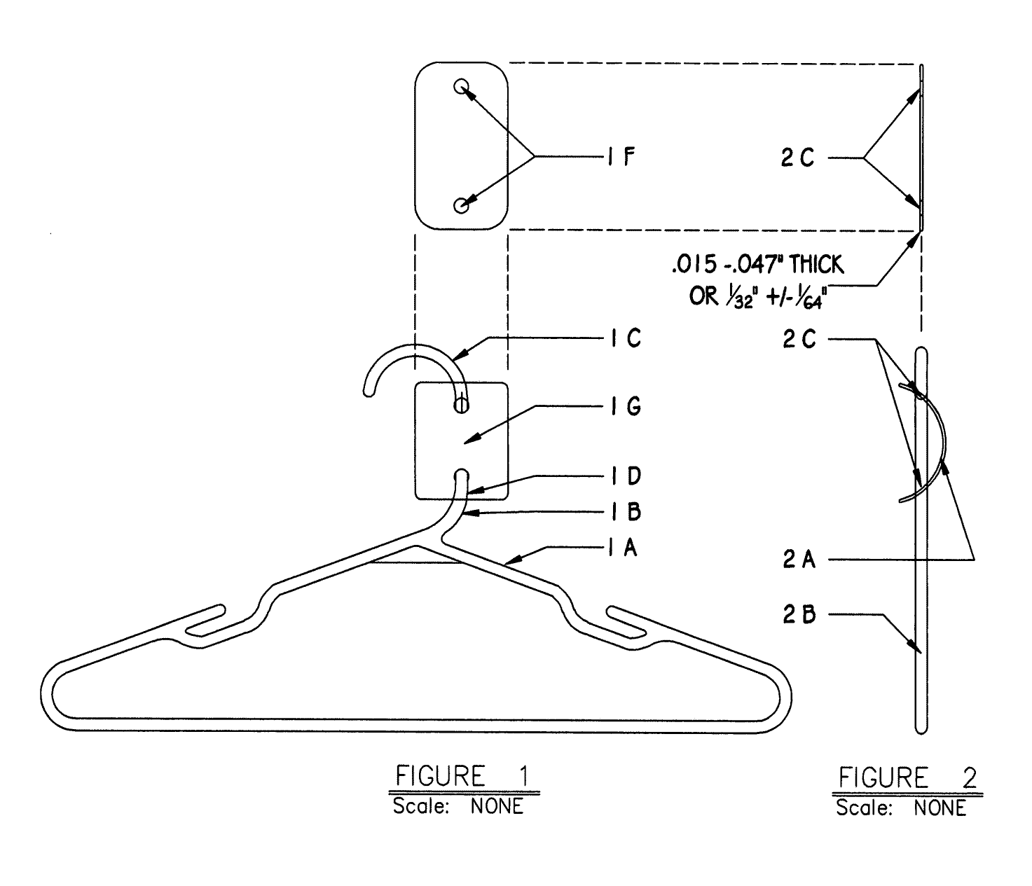

Shown in its conjoined position with said hanger in FIG. 2, the device 2A freely flows downward because of the flexibility in its manufactured material. The device 2A then generally maintains its initial connected position once fitted over hanger 2B.

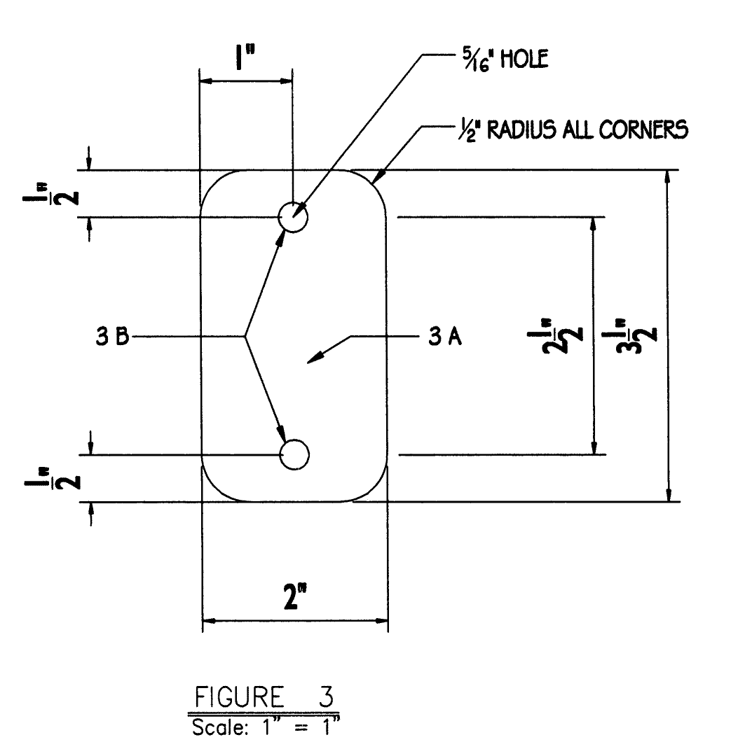

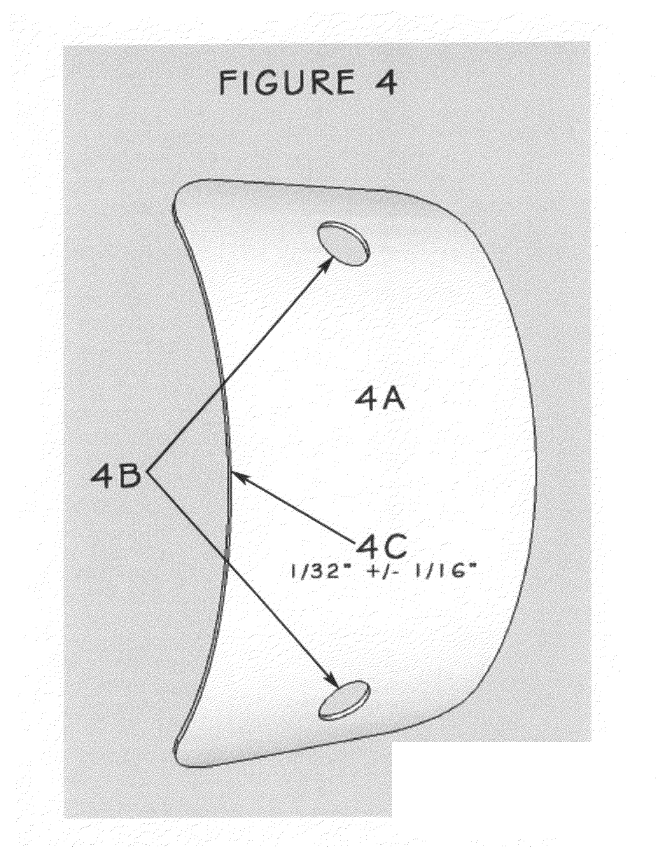

The invention depicted in FIG. 3, has conveniently placed openings shown at 3B slightly larger than a standard clothes hanger diameter such that said hanger hook and stem can be inserted through the openings without restriction. The device shown at 3A and its integral openings at 3B maintains its shape and durabilitiy such that the device can withstand repetitive threading and un-threading actions through the device openings at 3B for future use.

FIG. 4 depicts a 3D model layout of the device 4A, showing relationships between the device in total to the general position and size of its hanging openings at 4B and potential thickness shown as 4C. Approximate dimensions are depicted in FIG. 3 for purpose of relativity.

### PERSONAL AND COMMERCIAL APPLICABILITY

The device of the invention provides a method of marking the status of individual or multiple pieces of personal clothing, weather hung and marked individually, or with the device marking categories of clothing hung collectively such as possibly in a commercial application.

According to one aspect, the device allows the user to mark clothing in categories such as worn, unworn, to be worn, washed, unwashed, to be washed, dry-cleaned, and to be dry-cleaned. According to another aspect, the device allows the user to identify clothing as new, used, or categorize by size; and it allows the user to identify which clothes have been worn the day, week, or month before. According to another aspect, the device allows the user to organize articles or groups of clothing as to when they had been or should be worn. According to another aspect, a single device could identify the status of an infinite number of clothes hung by sections on as many hangers, with one device serving as the label for all articles of clothing in that section. Another aspect is that the device allows the user to identify individual or groups of clothing serving specific purposes such as work, dress or exercise.

Those skilled in the art will appreciate that numerous changes and modifications may be made to the above disclosed embodiments without departing from the spirit and scope of this invention.

What is claimed as the invention is:

1. An identification marking system for articles of clothing comprising of a device that temporarily affixes to a clothes hanger by inserting the hanger through the device integral hanging slots or openings. The upper portion of a clothes hanger, of any consistency like plastic or metal, that portion extending above the portion that an article of clothing is supported thereon, hangs the device. For purposes of clarity and user convenience the device can be referred to as a variety of ways such as device, tag, WearTag, identification marker, or marking system.

2. Said device hangs freely, constrained only by gravity and the confines of the integral slots or openings through which the upper portion of the hanger provides its support.

3. Said device has means to remain attached during normal handling of said hanger and permitting removal thereof manually. Once its current use is no longer required or the identification purpose is changed, said tag is removed for continued use by the reverse means of its attachment by sliding the tag up and around the upper hook portion of a hanger and stored until a further use in a similar application.

4. A marking system designed to identify articles of clothing according to the abstract, allowing flexibility in the application based on user requirements. Intended use allows one or more devices per hanger and single or multiple articles of clothing, hanging so that the device or devices remain visible.

5. A device that is generally oblong in shape with the integral hanging openings near the upper and lower portions. The device can consist of flexible yet durable material such as compressed foam or light plastic measuring approximately 3½″ in length, 2″ in width, and 1/32″+/− 1/64″ in thickness. The device has multiple color combinations for optional labeling and has identifying markings on at least one side. Identification and labeling of its conjoined article of clothing on the same hanger can be by the use of color variations of the device and/or by the color printed labeling on the device.
